(19) United States
(12) Patent Application Publication
(10) Pub. No.: US 2026/0208501 A1
(43) Pub. Date: Jul. 23, 2026

(54) GARMENT UNLOADER/LOADER WITH PROTECTIVE TRAY

(71) Applicant: Kornit Digital Ltd., Rosh HaAyin (IL)

(72) Inventors: Yinnon BOOKS, Tel-Aviv (IL); Pavel KOROLIK, Petah Tikva (IL); Elad FODOR, Petah Tikva (IL); Harel YIZHAK, Rehovot (IL); Dor Shlomo BEN DAVID, Shoham (IL)

(73) Assignee: Kornit Digital Ltd., Rosh HaAyin (IL)

(21) Appl. No.: 19/144,531

(22) PCT Filed: Dec. 27, 2023
(86) PCT No.: PCT/IL2023/051319

§ 371 Date: Jun. 30, 2025

Related U.S. Application Data
(60) Provisional application No. 63/436,134, filed on Dec. 30, 2022.
(60) Provisional application No. 63/436,140, filed on Dec. 30, 2022.

(51) Int. Cl. B41J 3/407; B25J 15/00; B25J 15/02; B41F 15/26; B41F 17/00

(52) U.S. Cl. CPC B41J 3/4078; B25J 15/0052; B25J 15/0206; B41F 15/26; B41F 17/005; B41J 3/40731

(57) ABSTRACT

An unloading and loading apparatus unloads garments from a printing pallet of a printer and loads the garment to a conveyor for post-printing processing. The apparatus has a robot arm that grips a garment from the printing pallet and travels between a pallet unloading position and a selected placement positions on the conveyor, the arm comprising grippers for gripping a garment. The garment is placed at the selected location on the conveyor but in so doing may travel over and touch or drip onto other garments already on the conveyor. Accordingly, a tray travels beneath the gripped garment over garments already in placement positions on the conveyor to provide protection.

### RELATED APPLICATION/S

This application claims the benefit of priority of U.S. Provisional Patent Application Nos. 63/436,134 filed on 30 Dec. 2022 and 63/436,140 filed on 30 Dec. 2022, the contents of which are incorporated herein by reference in their entirety.

### FIELD AND BACKGROUND OF THE INVENTION

The present invention, in some embodiments thereof, relates to a garment unloader/loader and, more particularly, but not exclusively, to a garment unloader/loader that is able to pick up garments from a conveyor, for example from a first treatment device, and load the garments onto a second conveyor, say associated with a second treatment device. The first treatment device may for example be a printer and the second treatment device may be for example a dryer.

In the past, human operators would transfer garments from a printer to a dryer located nearby. However, human operators are expensive, imprecise and need to take breaks.

In general it is not possible to use a single conveyor for both the printer and the dryer. In a garment printer, very precise position registration is needed so that different colors can be provided one after the other, and the mechanics for such precise registration would be liable to damage in the heater.

Thus, separate conveyors are required, and automatic unloading/loading systems have been developed to unload from the printer conveyor and load onto the dryer conveyor. Such a loading/unloading system provides an interface between a direct-to-garment (DTG) printer (either digital or screen based) and a dryer and the operation of the loader needs to be fully synchronized with the operation of the printer and the dryer.

The two systems are required to work together to provide high production volume with short and constrained cycle time and minimum overheads, thus requiring synchronization and ensuring that the printing system and the drying system have matching capacities.

The interface is required to handle, lift and place the delicate printed and wet garments without damaging the material or smudging the still wet print. The printed shirts then need to be placed on the dryer conveyor in the most suitable position, in specific and different lanes on the dryer's belt. Such may involve conveying printed shirts above other printed shirts that have already been placed at nearer positions on the conveyor. Yet a still wet shirt is liable to drip or touch the belt, smudging the shirts underneath.

Mishandling of a garment is likely, no matter how good the loader is. Likewise, identifying and dealing with print problems is needed, so that incorrectly printed shirts are efficiently removed. That is to say, faulty unloading, misprinted shirts and general mishandling need to be dealt with minimal effect on the system, in order not to stop the production process.

It is noted that as the printers get faster, manual unloading of the garments is too slow for the printer's pace, and unacceptable for human engineering aspects, the only solution is by pace of a high-capacity printer and thus an automatic unloader is required.

U.S. Pat. No. 6,484,629—Automatic textile unloader for a printing machine discloses what it terms a new apparatus and methods for automatically unloading or removing an article from a printing machine, and preferably transferring the same to a suitable drying surface. The apparatus includes a support frame, an extendable gripping means attached to the support frame for engaging the article, and a conventional controller for controlling operation of the extendable gripping means. Additionally, at least one platen attached to the printing machine in a manner allowing the extendable gripping means to vertically extend from the support frame to an area of the platen(s) is also disclosed. To permit gripping of the articles, the platen may be notched at the area corresponding to the extendable gripping means.

The disclosed apparatus is based on two or four grippers that pull shirts from pallets, typically on a screen-based printer carousal, with a small amount of lift, and convey them on the dryer's conveyor, to the same location each time (for example in the center lane of the dryer).

The solution is inadequate for a high-volume printer with a multi lane dryer of the kind discussed hereinbelow since it only allows for a single placement position on the dryer. This means that the dryer has to be long enough end to end to fully dry the shirt and yet the conveyor must be fast enough to accept a new shirt at the rate that the printer produces shirts. Thus a fast printer requires a very long dryer. Gripping is carried out with a single force for all garment types, and for any amount of ink laydown, yet the printer may have to deal with a wide range of different garments and printing operations that require specific settings. This causes mishandling of the garments, unwanted releases, staining, etc.

### SUMMARY OF THE INVENTION

The present embodiments may provide a fully automated controlled mechanical system to unload printed and wet garments from a high-volume printer (analog or digital) to its related drier with full synchronization with the printer's and drier's timing.

The present embodiments may include a set of garment grippers that pick-up the garments from the printing pallet and place them on the dryer's belt. The garment grippers may have controlled levels of force, say resulting from being connected to a suitable control system that controls their gripping force in accordance with the garment and the specific printed image attributes and sensitivity. In addition, a sensor may detect and monitor, during any part of the unloading process, whether a garment is actually gripped as intended by the particular gripper, and released as intended, that is flat on a selected location on the dryer conveyor with the printed surface face up. A controlled moving arm, perpendicular to the printer's conveying axis, may carry the gripped garments from the printer's unloading bay to one of the predefined positions on the dryer's belt.

A buffering and separation system may prevent garments that are being conveyed over other garments already placed on the conveyor from touching each other or dripping on each other or even touching the conveyer itself, thus preventing damage caused due to contact between them. The buffering and separation system may comprise a tray, the tray providing a buffer and drip tray, that moves under and with the grippers. The tray provides shielding between the gripped garment and the garments below, and may have raised edges to prevent dripping and may have a flange element to protect operators from the moving parts.

An algorithm may define how and where to position the garments on the dryer's conveyor belt, say in accordance with the dryer's utilization at any given time.

According to an aspect of some embodiments of the present invention there is provided an unloading and loading apparatus for unloading a garment from a printing pallet of a printer and loading the garment to a conveyor for post-printing processing, the apparatus comprising:
an arm configured to travel between a pallet unloading position and a selected one of a plurality of placement positions on the conveyor, the arm comprising grippers for gripping a garment at the pallet unloading position and placing the gripped garment at the selected one of the placement positions on the conveyor; and
a tray located to travel beneath the gripped garment over garments already in placement positions on the conveyor, thereby to provide shielding between the gripped garment and the garments already in position.

In embodiments, the tray is configured to stop at a placement position prior to the selected placement position.

In embodiments, the grippers are controllable to pull the gripped garment taut.

In embodiments, the arm is configured to place the garment while the conveyor is moving.

In embodiments, the tray is configured to catch drips from the gripped garment and to prevent the gripped garment from touching the already placed garments.

In embodiments, the tray comprises a flange, the flange located to face away from a direction of travel of the conveyor.

In embodiments, the flange is sized to prevent limbs from being inserted into a travel path of the arm.

Embodiments may have a manual operation mode, for which the tray is foldable to form a wall between the post processing apparatus and the pallet unloading position to protect an operator from moving parts in the pallet unloading position during the manual operation mode.

In embodiments, the at least one sensor is a position sensor, configured to sense a rotation position of a gripping finger holding the garment.

In embodiments, a visual detector may image the garment after gripping and compare the garment image with a corresponding print file to determine if the printing has been carried out correctly.

Embodiments may include a reject path for jettisoning any garments determined to be rejects.

Embodiments may determine from the grippers whether a given shirt is gripped at each gripper, and if not, to reject the given shirt.

Embodiments may detect print errors and reject any shirt showing print errors.

According to a second aspect of the present invention there is provided an unloading and loading method for unloading a garment from a printing pallet of a printer and loading the garment to a conveyor for post-printing processing, the method comprising:
gripping a garment from the printing pallet at a pallet unloading position;
transferring the gripped garment to a selected one of a plurality of positions on a conveyor for post printing processing;
providing shielding between the gripped garment and garments already located on the conveyor; and
releasing the gripped garment at the selected one of the plurality of positions on the conveyor for post printing processing.

Post printing processing is typically drying and/or curing, carried out in a dryer.

Unloading and loading may be carried out in synchronization with the printer and with the post printing processing. Thus, if the printer produces one printed garment say every nine seconds, the unloading and loading operations are completed in those nine seconds and the gripping mechanism is ready for the next pallet in that time. Likewise the dryer conveyor moves at a rate to provide one new drying position every nine seconds and the dryer is sized to dry all the garments when the dryer conveyor moves at that rate.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a view of a prior art garment unloader and loader device;

FIGS. 2A and 2B are details of the device of FIG. 1;

FIG. 3 is a simplified block diagram illustrating a garment printer and a dryer with an unloading/loading device interfacing between them according to embodiments of the present invention;

FIG. 4 is a view from above showing the location of garments before and after placing by the loading unloading device of the present embodiments;

FIG. 5 is the view of FIG. 4 additionally showing the reject path;

FIG. 6 is a cutaway perspective view showing the loader/unloader and the track on which the robot arm travels to transfer the garments;

FIG. 7 is a cutaway perspective view showing some of the view of FIG. 6 in greater detail;

FIG. 8 is a simplified flow chart illustrating the process of unloading a garment from a printing pallet and loading it onto a lane on a conveyor of the post-processing apparatus, according to embodiments of the present invention;

FIG. 9 is a simplified timing diagram illustrating how the unloading from the printer onto the post-processing apparatus may be synchronized with the timing of the printer, according to embodiments of the present invention;

FIGS. 10A-10C are three cutaway views of exemplary grippers according to embodiments of the present invention;

FIG. 11 illustrates two variations of procedures for providing variable gripping strengths according to embodiments of the present invention;

FIG. 12 is a simplified cutaway view illustrating an optical sensor on a gripper for detecting material being gripped according to embodiments of the present invention;

FIG. 13 is a simplified view showing operation of a position detector within a gripper according to embodiments of the present invention for detecting whether material is being gripped;

FIG. 14 is a simplified view showing the use of a strain gauge for detecting the force applied to pull the garment taut, according to embodiments of the present invention;

FIG. 15 schematically illustrates a garment being held loosely by grippers, according to embodiments of the present invention;

FIG. 16 is a simplified view of the garment in FIG. 15 being held tightly and imaged for quality control according to embodiments of the present invention;

FIG. 17 is a simplified view illustrating placement on the dryer conveyor of a garment held taut by the grippers and a garment held loosely by the grippers according to embodiments of the present invention;

FIG. 18 illustrates a garment being held loosely and carried over a garment loosely placed on the dryer conveyor by the gripping mechanism of the present embodiments;

FIG. 19 is a simplified diagram illustrating the use of a tray to provide shielding between the garment held in the grippers and garments already placed on the conveyor, according to embodiments of the present invention;

FIG. 20 is a simplified diagram illustrating travel of the tray and conveyors and positions of the garments as the tray passes, according to embodiments of the present invention;

FIG. 21 is a simplified diagram illustrating the gripping mechanism and tray and showing the protective flange of the tray according to embodiments of the present invention;

FIG. 22 illustrates the tray in a safety mode to protect manual operation in the zone of the dryer conveyor according to embodiments of the present invention;

FIG. 23 illustrates an embodiment of the present invention in which the tray of FIG. 22 is sloped to aid with positioning of sleeves and the like correctly on the dryer;

FIG. 24A illustrates an embodiment of the present invention in which the tray of FIG. 23 has a variable geometry; and

FIG. 24B illustrates the tray of FIG. 24A in an alternative geometry.

### DESCRIPTION OF SPECIFIC EMBODIMENTS OF THE INVENTION

The present invention, in some embodiments thereof, relates to a garment unloader/loader and, more particularly, but not exclusively, to a garment unloader/loader for taking garments from a first treatment device and loading the garments on a second treatment device.

An unloading and loading apparatus—hereinafter garment loader, unloads garments from a printing pallet of a printer and loads the garment to a conveyor for post-printing processing. The apparatus has a robot arm that grips a garment from the printing pallet and travels between a pallet unloading position and a selected placement positions on the conveyor, the arm comprising grippers for gripping a garment. The garment is placed at the selected location on the conveyor but in so doing may travel over and touch or drip onto other garments already on the conveyor. Accordingly, a tray travels beneath the gripped garment over garments already in placement positions on the conveyor to provide protection.

The tray may be a flat sheet of metal or may be concavely shaped or have flanges or be turned up around the edges to contain drips. Additionally, the tray may have a large flange on the outside edge facing the operator to shield the fast-moving parts of the robot arm and grippers from the limbs of the operator.

The tray may be used with garments that are held taut by the gripper system, or with garments that are loosely held.

The garment loader is intended for a high-volume printer with a multi lane dryer of the kind discussed hereinbelow in which the conveyor of the dryer has multiple positions side by side for garments and continually moves forward.

In a high-volume printer, the system's throughput, the number of printed shirts per hour, or TPT, is too high for a human operator to handle in terms of loading and unloading the shirts to and from the printer. Moreover, since the printer's TPT is extremely high, its working cycle, or tact time, must be kept very short, for example under 9 seconds for each shirt. Any deviation from the defined cycle time may jeopardize the synchronization of the system and eventually reduce the actual TPT or even cause the machine to stop.

These conditions dictate a very tight unloading requirement within the tact time. Thus, in an example, for a full cycle of 9 seconds, that correlates to 400 shirts per hour, the unloading time is limited to less than 8 seconds, including gripping the shirt, conveying it to its correct site and returning to pick up the next shirt, where the remaining 1 second is utilized for the other jobs of the printers. Obviously, no human operator can unload a shirt from the printer to the dryer in 8 seconds 400 times every hour, continuously, certainly not without smudging some of the printed images, or hurting himself.

Hence, an automatic system is needed, that can unload a printed and wet shirt from its pallet, remove it from the printer, place it in its correct and predefined location on the dryer and return on time to the printer to unload the next printed shirt.

Additional complexity arises from staggered placement of the garments on the drier conveyor, where each shirt must be placed in a very specific location (or lane) on the moving dryer's belt, the location being different every time. For example, in a 3-lane dryer (that can fit three shirts in parallel on its belt), the first shirt is placed in the first (near) lane, the second shirt in the second (middle) lane and the third shirt in the third (further) lane, and so forth for the following three shirts. The order dictates different paths for each shirt (e.g., the first has a short path and the last has a long path), and to move some of the printed shirts over other wet shirts that are already placed on the dryer.

Gripping is carried out with variable force depending on the garment data, so that heavy garments such as adult overcoats can be accommodated together with say children's shirts. Likewise, the gripping force may be adjusted depending on the amount of ink laydown and the amount of pre and post printing fluids, so the garment loader is able to accommodate any of a wide range of garments and printing operations that the printer may be able to undertake.

In order to manage gripping, sensors may be provided in the grippers. The use of managed gripping force also allows the grippers to apply stretching to the garments (without the danger of releasing them), which helps to ensure that at least the garments'printed areas are laid out flat on the conveyor.

The use of a buffering and separation system means that garments may be conveyed over other printed garments already placed on the dryer's conveyor

A rejection path may be provided, so that an incorrectly printed (as detected by an automated quality control QC system), or incorrectly gripped garment (as detected by the grippers'sensors) may be sent down the rejection path immediately, without slowing down or stopping the printing and/or drying operation.

The printer and dryer are connected to each other so that data may be supplied to the printer regarding the garment to be expected, the type of garment, the material, the image printed, etc. Thus incorrectly printed garments for example may be detected by imaging at the garment loader and sent down the rejection path.

A manual bypass may be provided in case of a major fault, to unload the garments using a human operator.

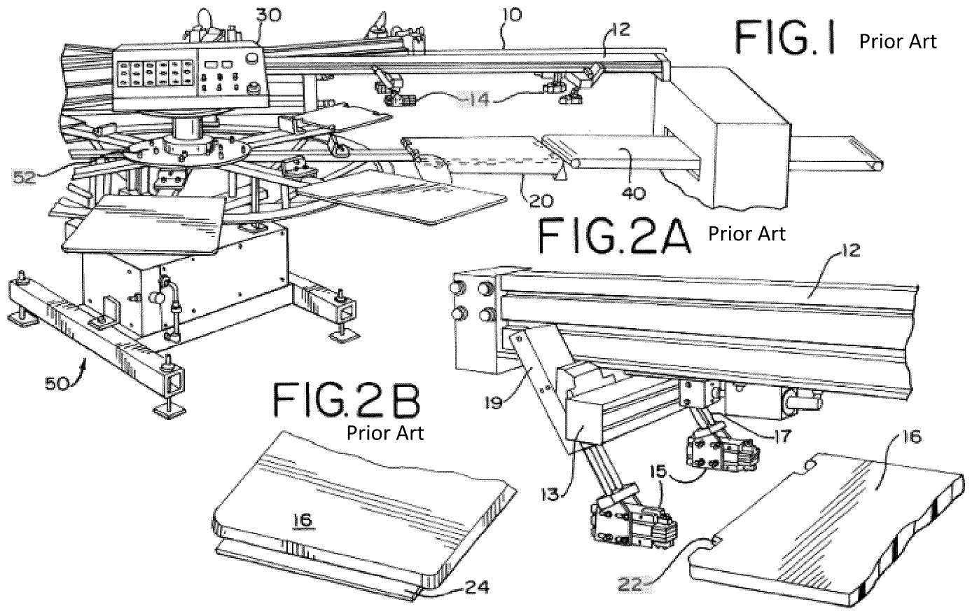

For purposes of better understanding some embodiments of the present invention, reference is first made to the construction and operation of an existing unloader/loader as illustrated in FIGS. 1, 2A and 2B.

As shown in FIG. 1 a prior art automatic unloader 10 is generally attached to a carousel type printing machine 50 at an open station. An open station is defined as a station of the printing machine 50 which is not used for printing, drying, or any other purpose uncooperative with the unloading of articles. The open station is preferably just after the last printing station of the printing machine 50.

The automatic unloader 10 is used to unload an article 20 from a screen printing machine 50 and place the articles 20 onto a second surface 40, such as a dryer rack, conveyor surface, or the like. The second surface 40 is preferably positioned to be adjacent the unloader 10, as illustrated in FIG. 1. The unloader 10 includes a support frame 12, an extendable gripping means 14 attached to the support frame 12 for engaging the printed article 20, and a conventional controller 30 for controlling the operation of the extendable gripping means 14.

The support frame 12 is preferably a radial arm of the printing machine 50, as shown in FIG. 1, made from an extruded aluminum, aluminum alloy, or any other strong, lightweight material. The support frame 12 is preferably channeled and extends a substantial distance from attachment to the printing machine 50. The extension allows an unloaded article to be placed directly onto the second surface 40 where the article 20 can be dried or cured before packaging. Additionally, the support frame 12 may include at least one spacer bar 13, preferably two spacer bars 13a and 13b, for providing adequate spacing between paired gripping means 14.

The extendable gripping means 14 may comprise at least one pair of jaws 15, possibly two pair of jaws 15, and even four pair of jaws 15. The jaws 15 may be operated using conventional pneumatic, hydraulic, electronic, or mechanical (e.g., a conventional stepper motor and conventional servo) controls to alternate between a closed position and an open position. The gripping pressure of the jaws 15 should be sufficient to grip and hold a relatively thin article (a single layer of material, for instance) under a given amount of lateral strain.

Where multiple pairs of jaws 15 are used it is advantageous to group them together by two's, as shown in FIG. 2A. For instance, the use of four pair of jaws is preferably configured having two pair of jaws 15 a on a front spacer bar 13a and two pair of jaws 15 b on a rear spacer bar 13b. The two spacer bars 13a and 13b are arranged a distance apart and attached to a drive mechanism (not shown) within the channel of support frame 12. The drive mechanism moves the spacer bars 13a and 13b, and thus the jaws 15, horizontally back and forth between a position above the platen 16 and a position above the second surface 40. The channel of the support frame 12 serves as a guide track 26 to the movement. The drive mechanism may be a continuous belt and pulley, a chain and sprocket, or any other conventional track capable of such reciprocating motion. Any conventional power plant, such as a motor, may be used to actuate the drive mechanism.

In order to reach the platen 16, each pair of jaws 15 is preferably capable of being vertically extended, via a telescoping rod 17, from a body portion 19 toward the platen 16. The telescoping rod 17 may allow extension up to about half a meter or more. Longer extensions, of course, may require additional support to insure the structural integrity of the mechanism.

The horizontal component of extension is a result of the angle of attachment of the jaws 15 to the spacer bars 13a and 13b. This angle of attachment (θ) may be within the range of from about 10° to about 80° relative to a line perpendicular to the support frame 12, as shown in FIG. 2A. Having the jaws 15 in a raised set position, allows the jaws 15 to be maintained out of the way of the rotating carousel 52 until needed.

The angle of attachment (θ), allowing lifting of the article 20 along the same angle, serves a two-fold function. First, in placing the articles 20 onto the printing machine platen 16, an adhesive is typically applied to keep the article from moving about as the carousel 52 turns. After printing, the article 20 can be quite attached to the platen 16 as a further result of the pressure applied during printing. In order to remove the article 20 quickly it is preferably lifted on an angle to break the contact between the article 20 and the platen 16.

Second, by permitting the slight horizontal travel of the jaws 15 upon retraction, the jaws 15 stretch the article 20 to maintain a taut printed indicia. These features help to prevent wrinkling, overlapping, creasing, or otherwise ruining the printed indicia of the article 20.

The platen 16 may be machined from metal stock, and may include at least one gripping area on the support surface 17. Preferably, the gripping area is comprised of four (4) notched areas or notches 22—FIG. 2A shows two notched areas 22 on one end of the platen 16—corresponding to the placement of the four jaws 15 and overlapped by the printed article 20. That is, as the jaws 15 are extended toward the platen 16, they encounter the article 20 at the four notched areas 22. The idea is to provide the platen 16 with a means which allows the article to be engaged and lifted from its supported position on the platen 16.

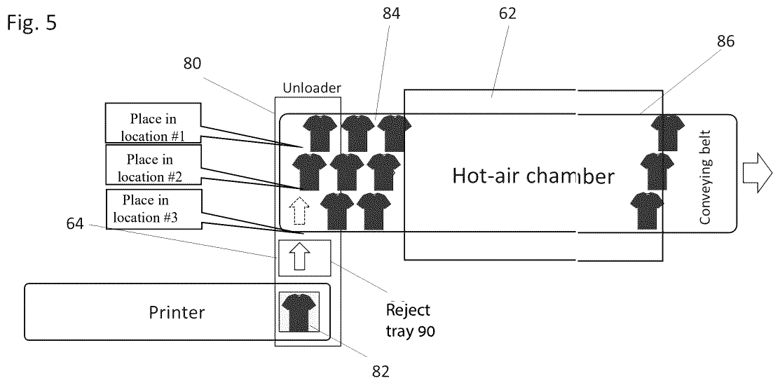

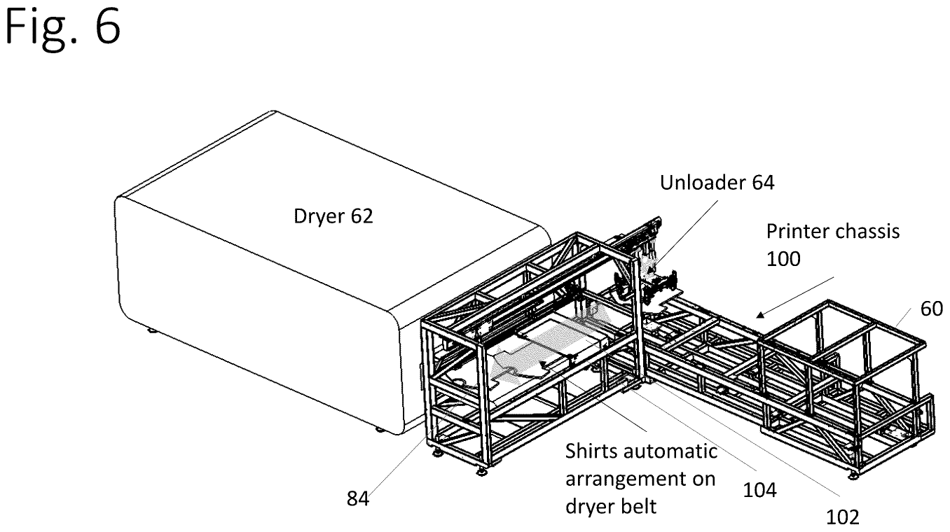

Upon closing the jaws 15, as shown in FIG. 5, the jaws 15 grip or engage the printed article 20 at the notched areas 22. As the jaws 15 are retracted, as shown in FIG. 6, the two pairs of jaws 15 a pull the article 20 slightly in one direction, while the two pair of jaws 15 b pull the article 20 slightly in a substantially opposite direction. At this point the printed indicium is held taut from four points of the article 20 preventing accidental transfer of ink on the article 20.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

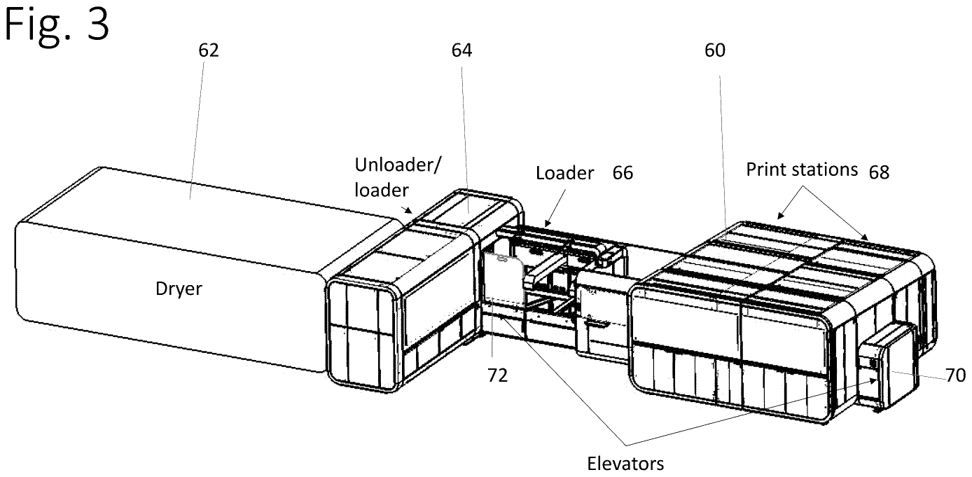

Referring now to the drawings, FIG. 3 illustrates the general layout of a printer 60 and a dryer 62 interfaced by a garment unloader 64 according to the present embodiments. The task of the garment unloader 64 is to unload garments from the printer 60 and place them on the conveyor of the dryer.

Briefly, garments are loaded onto printing pallets for the printer 64 at loading station 66 and are conveyed on the pallets to printing stations 68 for printing operations to be carried out. Following printing, the garments are lowered by elevator 70 and pass under the printing stations back towards the loading area and elevator 72. Here the printed shirts approach unloader 64 where they are removed from the pallets and placed on the conveyor of dryer 62.

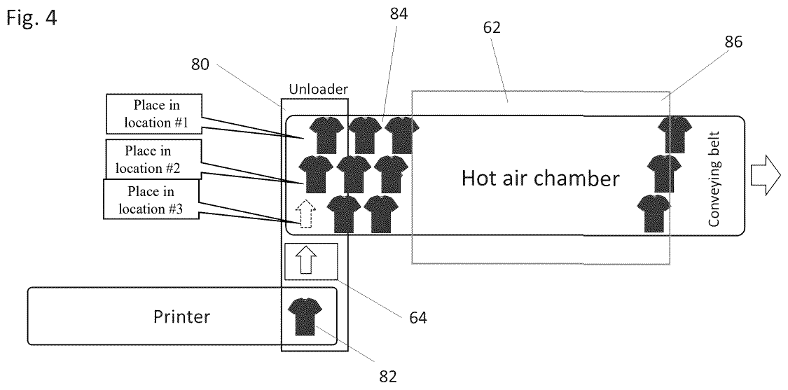

Reference is now made to FIG. 4, which is a view from above of the unloader 64 and the dryer 62 loading area 80. Pallets carrying garments such as garment 82 arrive from the printer and are removed from the pallets by grippers and placed on dryer conveyor belt 84. Dryer conveyor belt 84 is wide enough for three lanes of typical adult garments, thus providing three locations, #1, #2 and #3 at which the garment 82 may be placed on the conveyor 84. The conveyor is continually moving forward so that a stagger effect is provided in terms of the alignment of the garments. That is to say the conveyor always moves forward in the time it takes for the grippers to get another shirt. Thus if a Nth garment is placed in position #1, then an N+1st garment subsequently placed in position #2 will be behind the Nth garment in its position on the belt, as shown in FIG. 1. The dryer conveyor travels at a speed that ensures that the garments are inside the dryer for the necessary amount of time to emerge dried and cured at the far end 86 of the dryer.

Reference is now made to FIG. 5, which is a variation of the embodiment of FIG. 4 in which a reject path is provided. The same reference numerals are used for the same features and are not described again except as needed for an understanding of the present embodiment. If garment 82 appears not to have printed correctly, or if it is picked up incorrectly by the grippers, then the reject path is activated and the garment is not placed on the conveyor 84 but instead is placed in reject tray 90 located in the vicinity of garment loader unloader 82.

Reference is now made to FIG. 6, which is a simplified cutaway view of the loading and unloading area between the printer and dryer with paneling removed. Printer chassis 100 separates the loading/unloading area 64 from the printing area. Unloader 82 removes garments from the printing pallets and places them on the dryer belt 84. The unloader carries garments above belt 84 to their placement positions, and protective buffer plate 102 travels between the garment being carried and the belt 84 to shield the belt and any garments already placed from the garment being carried. Flange 104 at the outer end of protective buffer plate 102 provides protection against hands accidentally getting caught in the moving parts of the loader.

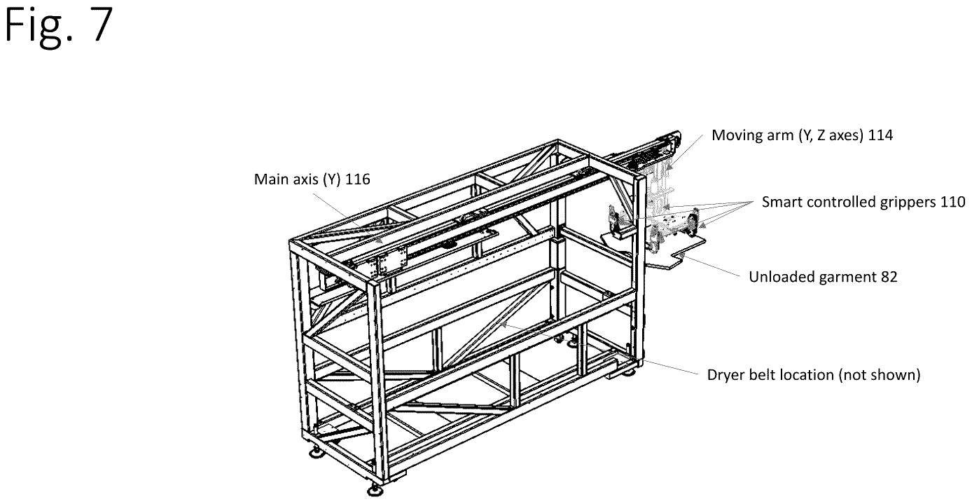

Reference is now made to FIG. 7, which is a simplified diagram showing a detail of the loading area from FIG. 6. The drier belt itself and the protective buffer plate 102 are removed for clarity. Garment 82 is held by grippers 110. The grippers are held on moving arm 112 which in turn runs on rail 114 along main Y axis 116.

In operation, the grippers pick up the shirt from the printing pallet, and raise the shirt above the height of the belt 84 and protective buffer plate 102. The garment is stretched taut as required for the specific fabric and ink load. The arm then proceeds along the rail 114 to a designated position on the belt 84 and the garment is placed on the conveyor while held taut, so that the garment is flat on the conveyor as it is released by the grippers. The buffer plate 102 follows the garment from underneath but only as far as the position prior to that on which the garment is released. Thus if the garment is taken to position 2, the tray remains at position 1, both because the garment cannot be released if the tray is underneath and because there is not going to be a garment underneath to protect at the designated position for placement of the current garment.

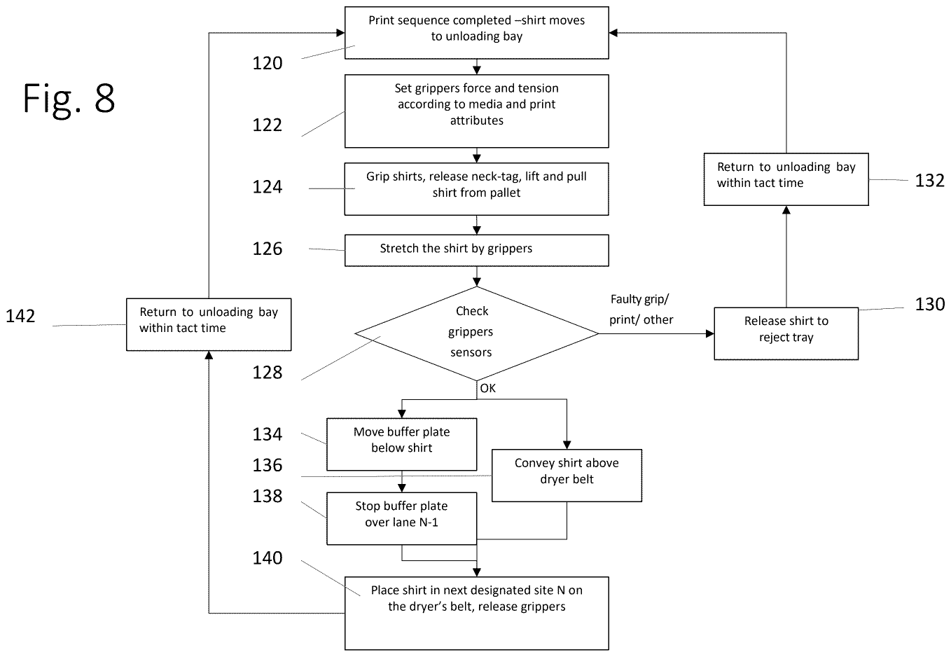

Reference is now made to FIG. 8, which is a simplified flow chart of the sequence of unloading a garment from a printing pallet and loading it onto the dryer belt according to embodiments of the present invention.

As the print sequence finishes the garment is moved to the unloading area—120. The grippers are set with a force and tension according to the media and print attributes—122. The information is typically available from the printer and sent directly to the controller. The grippers then grip the garments—124. If necessary, say with shirts, the neck, or neck tag may need to be released in a separate movement from the pallet. The grippers then stretch the garment—126.

At this point it is checked that each gripper is actually holding some of the garment—128. If not, then the shirt is released to the reject tray in 130 and the grippers return to pick up the next garment within the allocated time for the next shirt to arrive from the printer—132.

If the garment is correctly gripped then the buffer plate 102 is engaged and moves below the shirt—134. The shirt is conveyed above the dryer belt with the buffer plate moving underneath —136. The buffer plate stops one position short of the position in which the garment is to be placed —138, and the garment is laid down flat in the designated position on the dryer conveyor belt and the grippers release the garment—140. Box 142 indicates that the grippers return to the unloading position in time for the next garment coming out of the printer.

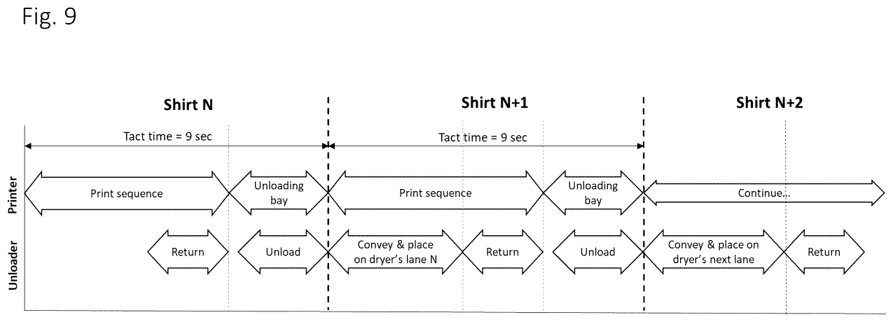

Reference is now made to FIG. 9, which is a timing diagram illustrating synchronization between the printer on the one hand and the unloader and dryer on the other. The diagram illustrates the printing and placement on the dryer conveyor of three garments, n, n+1 and n+2. The printer produces printed garments at intervals of nine seconds. The grippers thus have nine seconds to unload the garments from the pallet, carry them to the conveyor and place them in position and then return to the unload position. For each garment, the position to be placed on the dryer conveyor is incremented.

### Smart Grippers

In the textile printing field, it is required to handle and convey garments between different functional modules, to load garments to the printer, or unload garments from the printer after the printing phase. Usually, conveying the garments involves their gripping by mechanical devices, or gripping elements.

When conveying fabrics and garments with one or more gripping elements, the gripping force must be accurate to hold the garment weight, on one hand; while on the other hand, an excessive force can cause damage to the garment, for instance if the garment becomes stuck during its movement.

Different garments, say of different fabric type, with different payloads, say dry, or with ink, have different levels of gripping forces required. Garments may be made of cotton, polyester, blends, etc.; with many different designs, such as tee shirts, tops, leggings, hoodies, etc.; and with different sizes. Each combination requires different gripping force in order to have enough grip but without harming the fabrics by excessive force, and in addition, allows quick release of the garment in cases of a jam, or stuck garment.

Moreover, when an image is printed on the garment, the fluids used may change the garment characteristics and hence require a different setting of the gripper. For example, the ink and other fluids laid down on a tee shirt may add 100-300 grams to the shirt self-weight, which applies a much bigger resisting force on the grippers that extract the printed shirt from the pallet. This in turn requires a much higher gripping force to guarantee quality gripping.

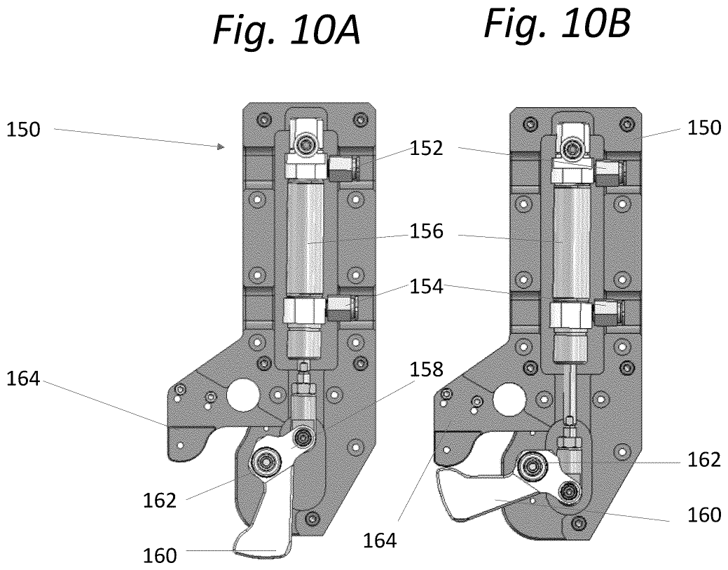

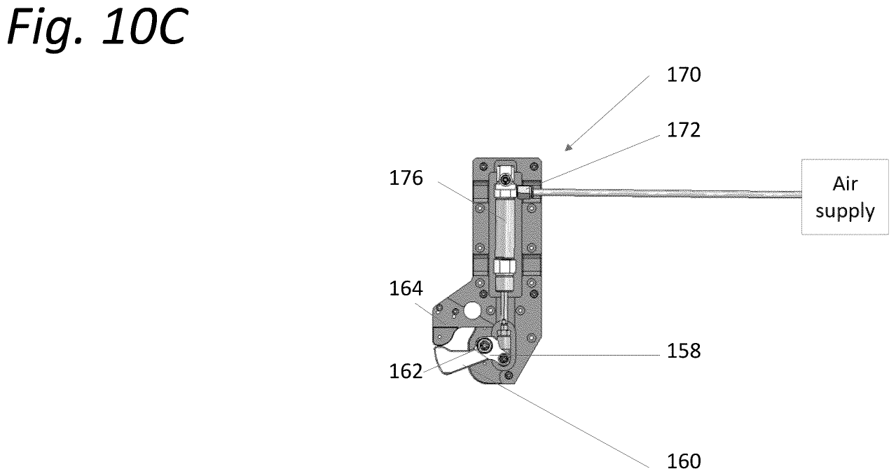

Reference is now made to FIGS. 10A and 10B, which are cross-sectional views illustrating a pneumatically operated gripper for use with the present embodiments. The associated mechanical assembly is based on a pneumatic piston and FIG. 10A shows the gripper in an open state, and FIG. 10B shows it in the closed state. Gripper 150 includes pneumatic inputs 152 and 154 leading to different parts of double piston 156. The piston being double can be manipulated to provide different gripping strengths. Thus valves can be operated to provide more or less air pressure to each input, and one or both inputs may be used at any given time. The piston is attached to lever 158 which in turn rotates moving gripping finger 160 about axis 162, thus transmitting the gripping strength. The result is that the movable gripping finger rotates between the open position shown in FIG. 10A and the closed position in FIG. 10B under the influence of the pneumatic piston and grips with the strength set by the pneumatics. In FIG. 10B the movable gripping finger closes against static gripping finger 164 and a garment edge is gripped between the movable and static fingers.

FIG. 10C illustrates a variation 170 of the gripper of FIGS. 10A and 10B in which a single pneumatic air input 172 is provided. Parts that are the same as in previous figures are given the same reference numerals and are not described again except as needed for an understanding of the present embodiment. Piston 176 is a single piston, and the gripping strength is controlled by using valves or any other suitable pressure adjusting component to control the pressure from the air supply.

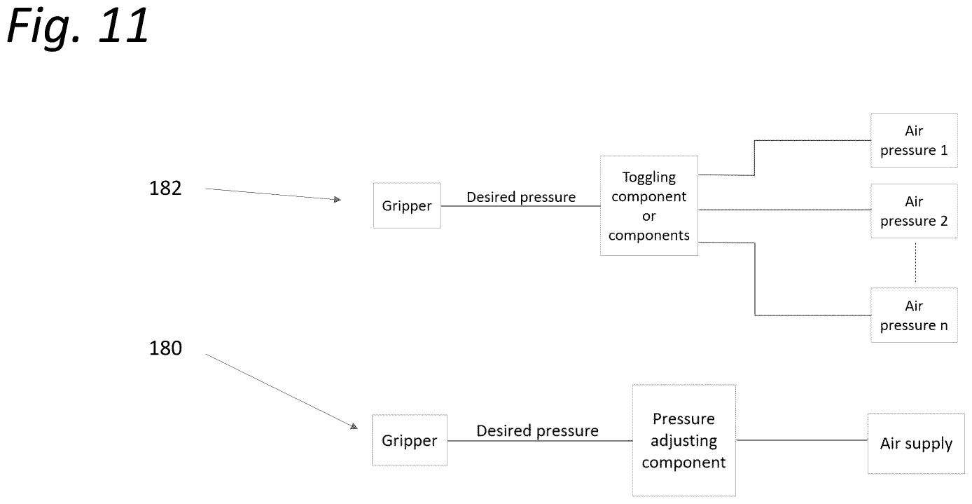

Reference is now made to FIG. 11, which is a simplified diagram illustrating control systems for controlling the gripping pressure of the pneumatic grippers according to an embodiment of the present invention, in the two cases of a single air supply 180 and multiple air supplies 182. In both cases the desired gripping strength is obtained, typically based on information from the printer regarding the type and thickness of the material and the amount of printing fluid. The desired pressure is then matched by toggling components to activate either fully or partly each of the air supplies in the multiple case. The components may be actuated valves that turn on or off, either partially or fully, each air supply. In the single air supply case, the components may adjust the air pressure at the pneumatic source, or may be valves, or a combination of the two.

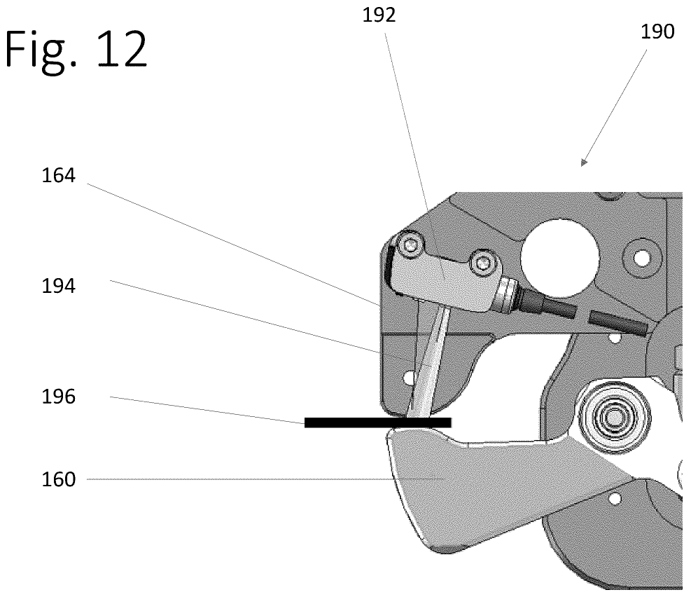

Reference is now made to FIG. 12, which illustrates a gripper 190 according to an embodiment of the present invention using an optical detector to detect gripped material in the gripper. Optical element 192 is located in static gripping finger 164, and looks through clear path 194 at the point between the two gripping fingers where gripped fabric 196 may be held. In one embodiment the detector detects the presence of a fabric, and/or a specific color such as black. In other embodiments the detector detects any color change over the background provided by the movable gripping finger 160.

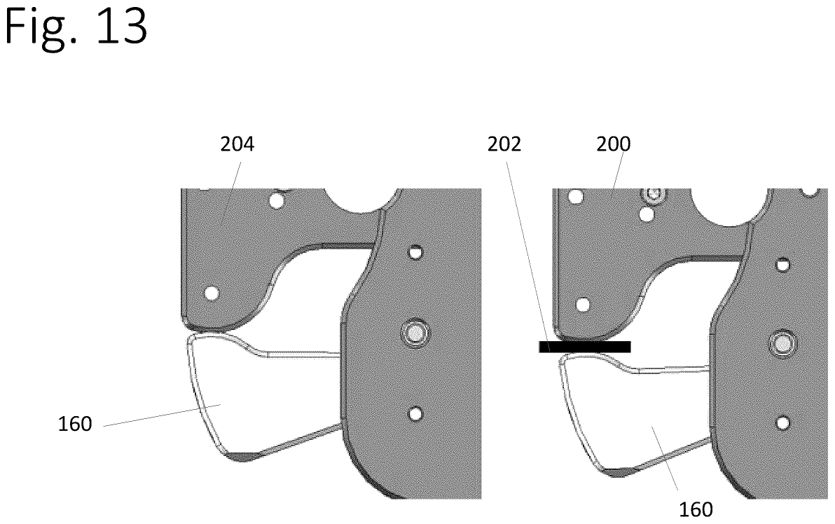

Reference is now made to FIG. 13, which is a simplified diagram illustrating a variation of the embodiment of FIG. 12, in which indirect measurement is used to detect the presence or absence of fabric in the grippers. Gripper 200 has fabric 202 between the gripping fingers, whereas gripper 204 does not. The angular position of the movable gripping finger 160 is detected to determine whether fabric is held or not.

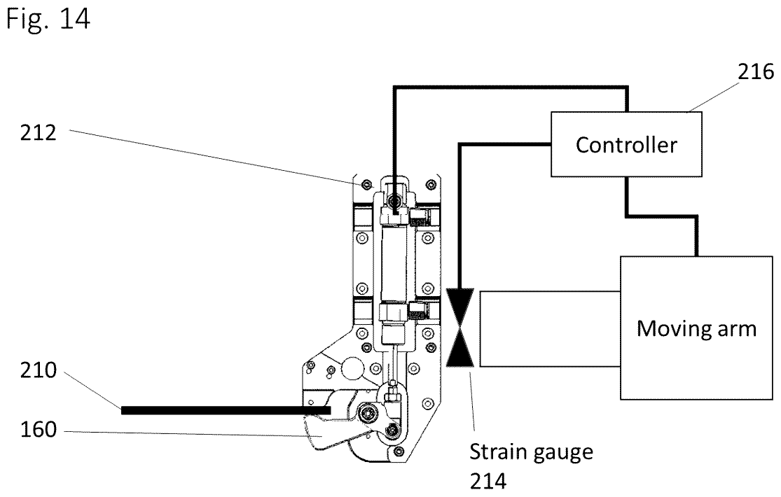

Reference is now made to FIG. 14, which illustrates the use of a strain gauge to monitor the stretching force applied by the gripper on the fabric, and release the garment from the gripper if the force is higher than the predetermined force, thus risking tearing of the fabric. Fabric 210 is held in gripper 212 and the gripper then pulls on the material to stretch it taut. The strain gauge 214 measures the resistance of the garment and if the resistance reaches a predetermined maximum threshold for the given material, then controller 216 opens the movable gripping finger 160 and releases the garment. The threshold may be set at a level sufficient to stretch the garment but above which the garment may tear.

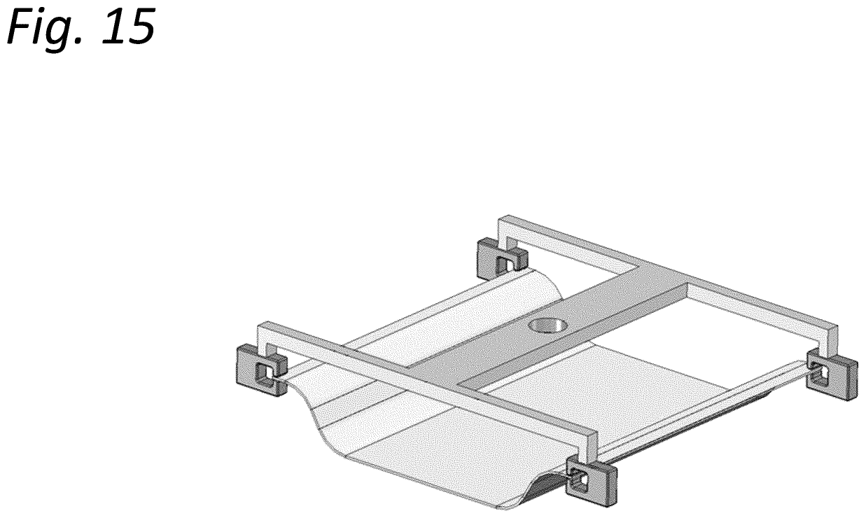

Reference is now made to FIG. 15, which is a simplified diagram illustrating how a garment 220 may be held at four corners by grippers 222. The grippers are held on a frame 224 and the frame may be held by a robot arm that travels on a rail, as discussed hereinabove.

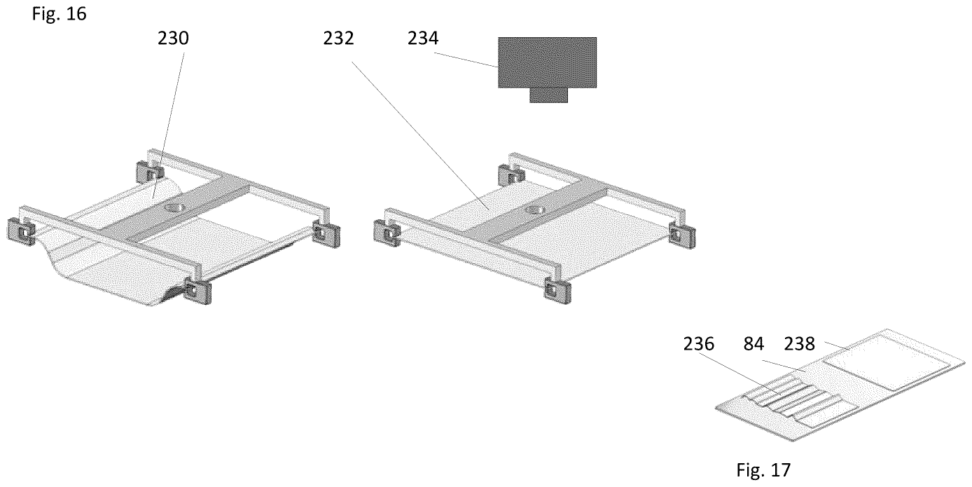

Referring now to FIG. 16, and garment 230 sags between the grippers. However garment 232 is taut. Movement of the grippers in the direction away from each other allows the garment to be pulled taut, and when taut, the garment may be visually inspected, say by visual inspection system 234, to check that the printing has been done correctly. For example, visual inspection system 234 may take an image of the taut garment and compare the image to the corresponding print file. If the two are not the same then the garment may be rejected at this stage.

Another reason to hold the garment taut is so as to allow flat placement on the drier conveyor. As shown in FIG. 17, garment 236 is placed as is on drier conveyor 84. Garment 238 is first held taut in the gripper and then placed on the drier conveyor 84. The garment 84, being flat, is more evenly exposed to the various forms of heat in the dryer.

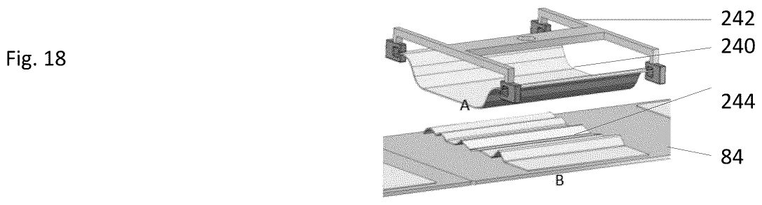

Reference is now made to FIG. 18 which shows garment 240 loosely held in grippers 242. The garment 240 passes over garment 244 to get to its designated position on drier conveyor 84. Garment 244 is not flat on the conveyor and the chances of the two garments touching each other, or the upper garment dripping on the lower garment, are relatively high. Such touching or dripping may cause color contamination to the still wet images.

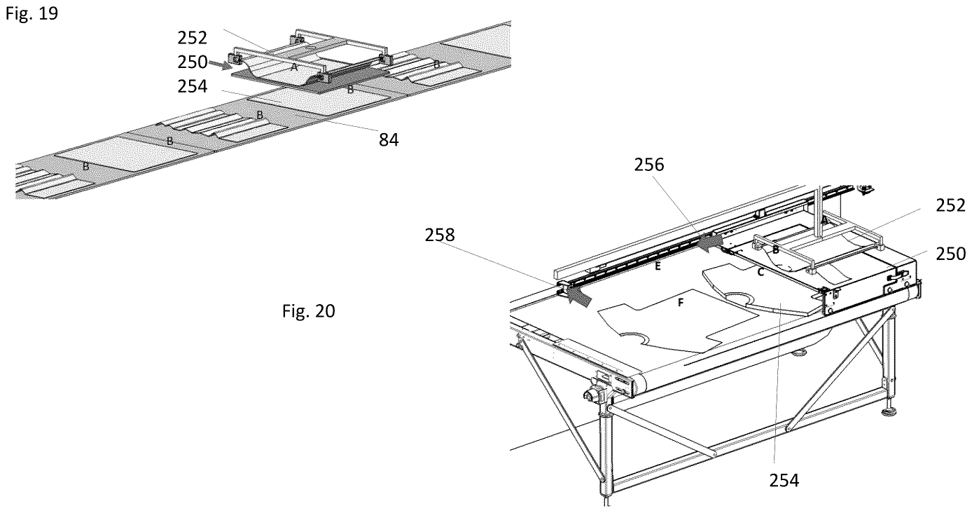

Reference is now made to FIG. 19, which is a simplified diagram illustrating the use of a protective buffer plate 250 to catch drips and prevent contact between upper garment 252 and lower garment 254. As the buffer plate provides a physical barrier, contact is prevented whether the garments are taut or not, and the physical barrier catches any dripping. As discussed above, the buffer plate moves with the grippers.

FIG. 20 shows the view of FIG. 19 in more detail. As before, a protective buffer plate 250 catches drips and prevent contact between upper garment 252 and lower garment 254. The gripper, upper, gripped, garment 252 and buffer tray 250 move in the direction of arrow 256, while the dryer conveyor 84 moves in the direction of arrow 258. Shirt 254, already placed on the conveyor, is shown disappearing under the buffer tray 250 as the buffer tray moves across.

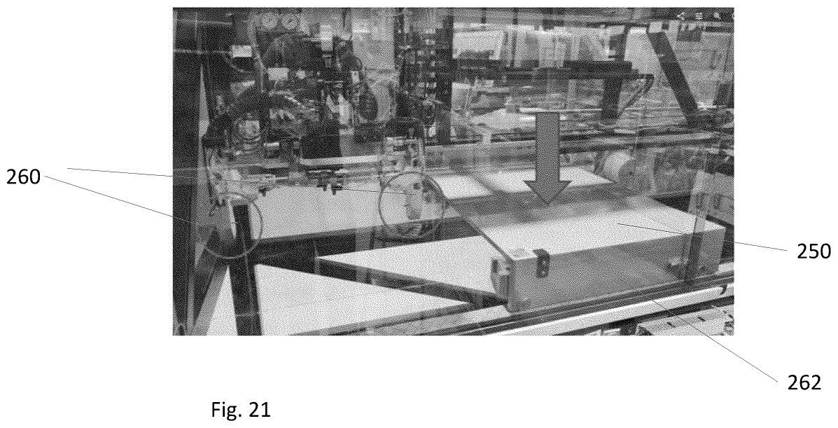

Reference is now made to FIG. 21, which illustrates gripper arms 260 and buffer tray 250. The buffer tray travels with the gripper but stops at the position before the garment is deposited on the belt as discussed above. Flange 262 on the front of the buffer tray towards the users prevents users from inadvertently getting their hands in the way of the moving parts of the device.

In some circumstances, it may be necessary to place garments on the drier conveyor manually. In such a case, the buffer plate 150 may be parked in a vertical position to prevent the gripper from interfering with the hands of the operator, and also to keep the operator's hands away from the region 264 in which moving parts may still be operating, here marked as the danger zone.

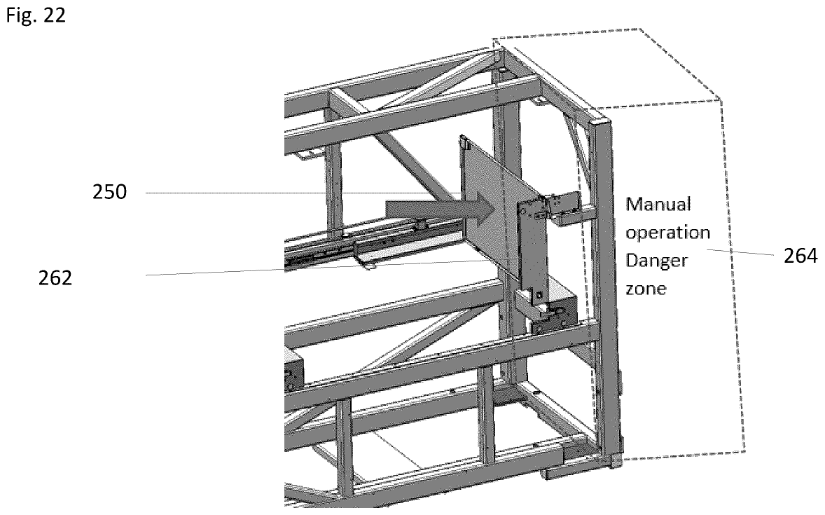

Reference is now made to FIG. 22, which illustrates tray 250 in a safety mode to protect manual operation in the zone of the dryer conveyor according to embodiments of the present invention. The tray travels under the garment on the unloader as before, to prevent contact or dripping of wet ink, etc, from the current garment to those already placed on the belt underneath. Due to movement of the unloader and associated grippers, a moving danger zone is created in the region where the unloader passes. A flange 262 on the tray 250 prevents a user from inserting an arm into danger zone 264 where the arm is in danger of colliding with the robot arm. In other words, the flange prevents limbs and the like from being placed in the travel path of the unloader.

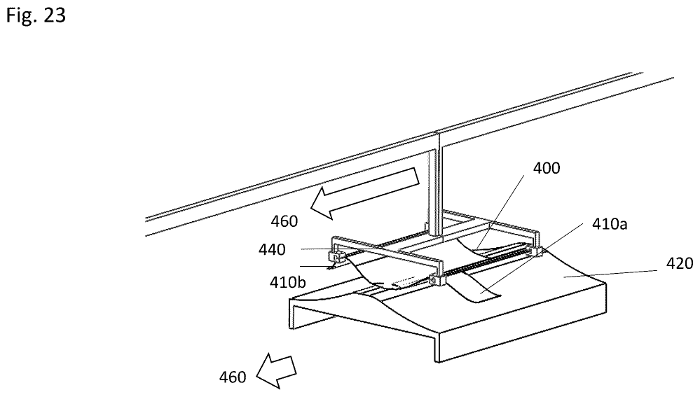

Reference is now made to FIG. 23, which is a simplified diagram showing the unloaded garment 400 being held by the gripper and moved by the unloader 440 in direction 460. The unloader may be carrying the shirt towards a destination such as the belt of the dryer. The protective tray 420 moves simultaneously with the gripper under the unloaded garment 400 to protect the lower garments that may be already positioned on the dryer belt and which the shirt may otherwise touch or drip over.

In the embodiment as illustrated, the protective tray 420 is sloped towards the outside in the widthwise direction with respect to direction of travel 460. The sleeves 410a of the garment fall from the garment 400 and drape over the slopes on the respective sides. The sleeves thus drape outwardly, which allows the garment to be offloaded onto the belt in such a way that the sleeves extend outwardly as necessary rather than being folded under the garment and create high wrinkles in the dryer and may prevent homogeneous drying. In other words, the sleeves 410a and 410b are placed in a suitable geometry to allow opening of the garment to its required geometry for optimal drying on the belt.

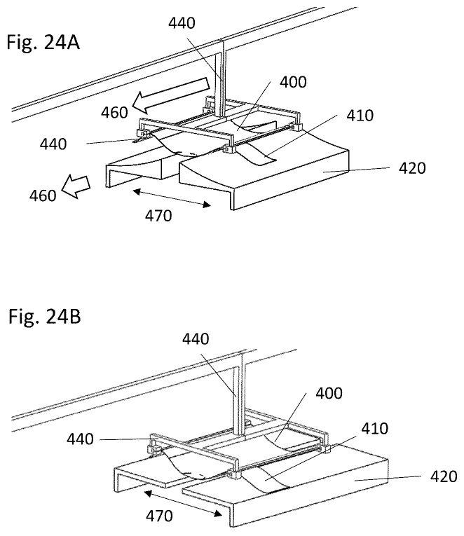

Reference is now made to FIGS. 24A and 24B. The protective tray 420 is automatically adapted on-the-fly by the systems controller (not shown) to change its geometry in order to set the garment 400 in accordance with its specific shape and size, the ink weight, etc. before being placed on the next station such as the dryer's belt (not shown).

In the embodiments shown in FIGS. 25A and 25B the tray 420 may be broadened by opening out widthwise as indicated by arrow 470 and the slopes of the sides may be adjusted, say according to sizes of sleeves. The garment 400 moves above the tray as the tray is adjusted to the correct geometry for the specific garment 400 currently being moved by the unloader 440 for placing on the belt for the next step in the process. That is to say each garment is picked up by the unloader 440 and the time taken up by the transit is used to adapt the geometry of the tray in time for the garment to be placed correctly on the belt, so that no additional delay is added to the system due to varying the tray geometry.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. An unloading and loading apparatus for unloading a garment from a printing pallet of a printer and loading the garment to a conveyor for post-printing processing, the apparatus comprising:
an arm configured to travel between a pallet unloading position and a selected one of a plurality of placement positions on the conveyor, the arm comprising grippers for gripping a garment at said pallet unloading position and placing said gripped garment at said selected one of said placement positions on said conveyor; and
a tray located to travel beneath the gripped garment over garments already in placement positions on the conveyor, thereby to provide shielding between said gripped garment and said garments already in position.

2. The apparatus of claim 1, wherein said tray is configured to stop at a placement position prior to said selected placement position.

3. The apparatus of claim 1, wherein said grippers are controllable to pull said gripped garment taut.

4. The apparatus of claim 3, wherein said arm is configured to place said garment while said conveyor is moving.

5. The apparatus of claim 4, wherein said tray is configured to catch drips from said gripped garment and to prevent said gripped garment from touching said already placed garments.

6. The apparatus of claim 1, wherein said tray comprises a flange, the flange located to face away from a direction of travel of said conveyor;
wherein said flange is sized to prevent limbs of a user from being inserted into a travel path of said arm;
wherein said apparatus comprises a manual operation mode, and wherein said tray is foldable to form a wall between said post processing apparatus and said pallet unloading position to protect an operator from moving parts in said pallet unloading position during said manual operation mode; and
wherein said apparatus comprises at least one position sensor configured to sense a rotation position of a gripping finger holding said garment.

7-9. (canceled)

10. The apparatus of claim 1, further comprising a visual detector for imaging the garment after gripping and comparing the garment image with a corresponding print file to determine if the printing has been carried out correctly.

11. The apparatus of claim 1, further comprising a reject path for jettisoning any garments determined to be rejects; and
wherein said apparatus is configured for one or more of:
a. determine from said grippers whether a given shirt is gripped at each gripper, and if not, to reject said given shirt;
b. detect print errors and to reject any shirt showing print errors.

12-13. (canceled)

14. The apparatus of claim 1, claims, wherein said tray comprises downward slopes on respective sides towards a widthwise extremity; and wherein said downward slopes are adjustable.

15. (canceled)

16. The apparatus of claim 1, wherein said tray is configured for one or more of:
a. being adjustable in a widthwise direction; and
b. to be adjusted geometrically during said traveling beneath said gripped garment.

17. (canceled)

18. An unloading and loading method for unloading a garment from a printing pallet of a printer and loading the garment to a conveyor for post-printing processing, the method comprising:
a. gripping a garment from the printing pallet at a pallet unloading position;
b. transferring the gripped garment to a selected one of a plurality of positions on a conveyor for post printing processing;
c. providing shielding between said gripped garment and garments already located on said conveyor; and
d. releasing the gripped garment at said selected one of said plurality of positions on said conveyor for post printing processing.

19. The method of claim 18, wherein said providing shielding comprises providing a tray, the tray traveling under the gripped shirt;
wherein said tray travels between said gripped garment and any other garments already placed on said conveyor;
wherein said tray starts traveling from a location after said pallet unloading position;
wherein said tray travels under said gripped garment from said position after said pallet unloading position to a position prior to said selected one of said positions on said conveyor; and wherein said conveyor travels during placement of said gripped garment.

20-23. (canceled)

24. The method of claim 19, comprising providing a flange on said tray to shield moving parts.

25. The method of claim 24, comprising providing a manual operation mode for said post processing, and folding said tray to form a barrier with said pallet unloading position to shield an operator from moving parts in said pallet unloading area during said manual operation mode.

26. The method of claim 18, wherein said unloading and loading is carried out in synchronization with said printer and with said post printing processing.

27. The method of claim 18, wherein said post printing processing comprises drying and/or curing.

28. The method of claim 18, wherein said shielding comprises downward slopes on respective sides towards a widthwise extremity.

29. The method of claim 28, comprising adjusting tilts of said downward slopes.

30. The method of claim 18, further comprising adjusting said shielding in a widthwise direction.

31. The method of claim 18, further comprising adjusting said shielding geometrically during said transferring of said gripped garment.
